(19) United States
(12) Patent Application Publication
(10) Pub. No.: US 2002/0024420 A1
(43) Pub. Date: Feb. 28, 2002

(54) Key for selectively allowing access to an enclosure

(76) Inventors: Raymond F. Ayala, San Diego, CA (US); Philip J. Finlay, Chula Vista, CA (US); Jeffrey L. King, San Marcos, CA (US); Steven Shannon, San Diego, CA (US); Woodrow C. Stillwagon, Atlanta, GA (US)

Correspondence Address: Terry J. Anderson, Esq., NORTHROP GRUMMAN CORPORATION, 1840 Century Park East, Los Angeles, CA, 90067-2199, US

(21) Appl. No.: 09/892,825

(22) Filed: Jun. 27, 2001

Related U.S. Application Data
(63) Continuation-in-part of application No. 09/372,525, filed on Aug. 11, 1999.
(60) Provisional application No. 60/096,251, filed on Aug. 12, 1998.

(51) Int. Cl. G06F 7/04

(52) U.S. Cl. 340/5.61; 340/10.34

(57) ABSTRACT

A key for selectively allowing access to an enclosure having an unpowered lock and a lock controller is disclosed. The key comprises: a housing. Located within the housing are: a processor operative to build variable signals for transmission from the key to the lock controller and to interpret the variable signals received by the key from the lock controller; a storage device in communication with the processor, the storage device operative to store data for building and interpreting the variable signals being alternately transmitted between the key and the lock controller for validating that the key is authorized to access the enclosure; a data transmitter in communication with the processor, the data transmitter operative to wirelessly transmit signals from the key to the lock controller, to inductively transmit an access request signal to the lock controller upon proper alignment with the lock controller, and to transmit an interrogation response signal in response to receiving to a variable interrogation request; a data receiver in communication with the processor, the data receiver operative to receive the variable interrogation signal; and a power transmitter in communication with the processor for wirelessly transmitting power to the lock controller simultaneously with the transmission of data.

### CROSS-REFERENCE TO RELATED APPLICATIONS

This application is a continuation-in-part of U.S. application Ser. No. 09/372,525, filed on Aug. 11, 1999, the entirety of the disclosure of which is expressly incorporated herein by reference, which claims the benefit of U.S. Provisional Application Ser. No. 60/096,251 filed Aug. 12, 1998, the entirety of the disclosure of which is expressly incorporated herein by reference.

### BACKGROUND OF THE INVENTION

The present invention is generally directed to locking devices, and more particularly to a system and method for controlling access to vending machines and similar enclosures.

Latching or locking devices are commonly used to hold lids, doors or other closure elements of boxes, cabinets, doorways and other framed structures in closed and/or locked positions. Such devices are typically used to provide some measure of security against unauthorized or inadvertent access. For example, conventional vending machines generally include a key operated latch or locking device that typically includes a latching assembly and a post mounted to the frame and door of the vending machine so that the door of the vending machine is automatically locked when moved into a closed position against the machine frame by the insertion of the post into the latching assembly.

Typically, to disengage the latching assembly from the post, these latching assemblies utilize key locks in which a key is received, and, as the key is turned, the biased latching elements of the assembly are released from engagement with the post to enable the door or other closure element to which the latch is mounted to be opened. Examples of such latching assemblies for use with vending machines or similar enclosures are disclosed in U.S. Pat. Nos. 5,050,413, 5,022,243 and 5,467,619. Such an unlocking or opening operation generally is a substantially manual operation such that most latching assemblies generally are limited in their placement to regions or areas where they can be readily reached and operated, e.g., in the middle of the door. Such easy access to these latching assemblies, however, tends to make these latching assemblies easy targets for vandals or thieves who can shield their actions from view while attacking the security of the enclosure by picking or smashing the lock to remove the primary and sometimes only point of security between the door and the frame of the enclosure.

In particular, vending machines have become an increasingly favorite target of vandals and thieves. The popularity of vending machines has increased greatly in recent years, especially in remote areas for providing ready access to an increasing variety of goods including food and drinks, stamps, and higher priced items such as toys and cameras, all without requiring human intervention. The increased popularity coupled with an increased capacity of vending machines as well as the expansion of products to higher priced items have significantly increased the amounts of money taken in by vending machines, providing an increasingly attractive target to thieves and vandals.

Further, if the key to one of these latching assemblies or locking devices is lost or stolen, all the locks accessible by such key must be “re-keyed” to maintain controlled access and security. Such re-keying is typically burdensome and very costly, especially where there are a significant number of locks that need to be re-keyed. Accordingly there is an increasing interest in improving the security of latching and locking assemblies for securing the doors or other closure devices of vending machines and similar enclosures.

There also exists a problem of monitoring and auditing the amount of time required for a service technician to access and service devices such as vending machines, automatic teller machines, gambling machines or other automated kiosks or containers. It is therefore difficult for many companies to develop a good schedule or concept of the total time required to service such vending devices or machinery to better plan service routes and/or allocate or assign service technicians. This problem is further compounded by conventional latching systems that require the post of the latch to be rotated through multiple revolutions to fully release it from the latch assembly. Such additional time required to disengage and open the latching assembly may seem small per individual machine, but constitutes a significant expenditure of time that can be burdensome, for example, for a company that has a large number of vending machines that must be serviced, by significantly increasing the amount of time required to service each particular vending machine.

There is, therefore, a need for improved latching systems and methods that address these and other related and unrelated problems.

### BRIEF SUMMARY OF THE INVENTION

The present invention is directed to a key for wirelessly powering and selectively allowing access to an enclosure identified by an enclosure identification, the enclosure having an otherwise unpowered enclosure lock controller to control an electric enclosure lock mechanism, the key and the lock controller in two-way communication for transmitting and receiving variable signals for validating that the key is authorized to access the enclosure, the variable signals being alternately transmitted between the key and the lock controller to deter detection and duplication of the variable signals to prevent unauthorized access to the enclosure. The key comprises: a housing; a processor located within the housing, the processor operative to build the variable signals for transmission from the key to the lock controller and to interpret the variable signals received by the key from the lock controller; a storage device located within the housing in communication with the processor, the storage device operative to store data for building and interpreting the variable signals being alternately transmitted between the key and the lock controller for validating that the key is authorized to access the enclosure; a data transmitter located within the housing in communication with the processor, the data transmitter operative to wirelessly transmit signals from the key to the lock controller, to inductively transmit an access request signal to the lock controller upon proper alignment with the lock controller, and to transmit an interrogation response signal in response to receiving to a variable interrogation request; a data receiver located within the housing in communication with the processor, the data receiver operative to receive the variable interrogation signal; and a power transmitter located within the housing in communication with the processor for wirelessly transmitting power to the lock controller simultaneously with the transmission of data.

In accordance with yet further aspects of the invention, the key further comprises: a plurality of date sensitive key activation codes stored in the storage device; and a keypad located on the external surface of the housing used for entering one of the date sensitive key activation codes.

In accordance with still further aspects of the invention, the key further comprises a display located on the external surface of the housing.

In accordance with further aspects of the invention, the key selectively allows access to the enclosure via wireless simultaneous transfer of data and of power to the lock controller using a method of transmitting the variable signals comprising: transmitting the access request signal identifying the key from the key to the lock controller; receiving by the key, the variable interrogation signal from the lock controller, in response to the access request signal; decoding the variable interrogation signal to determine an enclosure identification and identify a variable interrogation question, the variable interrogation question corresponding to one of a plurality of possible interrogation questions; validating that the key is authorized to access the enclosure by comparing the enclosure identification to a list of authorized enclosure identifications stored in the key; computing the interrogation response signal using a selected stored cipher variable corresponding to the interrogation question and the enclosure identification, in response to a key validation; transmitting the interrogation response signal from the key to the lock controller; and repeatedly transmitting power from the key to the lock controller until the key receives a signal from the lock controller indicating that sufficient power has been received by the lock controller to send an open signal to the enclosure lock.

### BRIEF DESCRIPTION OF THE DRAWINGS

These as well as other features of the present invention will become more apparent upon reference to the drawings wherein:

FIG. 1 is a block diagram illustrating major components of a system for controlled access to an enclosure via a lock controller formed in accordance with the present invention;

FIG. 2 illustrates the route manager computer shown in FIG. 1;

FIG. 3 illustrates an exemplary key of FIG. 1;

FIG. 4 illustrates data stored in the key shown in FIG. 3;

FIG. 5 illustrates data stored on the lock controller shown in FIG. 1;

FIG. 6 is a flow diagram illustrating exemplary logic performed by the route manager computer;

FIG. 7 is an exemplary screen display for a route manager program as shown in FIG. 6;

FIG. 8 is a flow diagram illustrating exemplary logic for loading data from the route manager onto the key;

FIG. 9 is an exemplary screen display for loading data from the route manager computer onto the key;

FIG. 10 is a schematic illustration of an exemplary key shown in FIG. 1;

FIG. 11 is a schematic illustration of an exemplary lock controller shown in FIG. 1;

FIG. 12 is an exemplary illustration showing simultaneous transmission of data and power from a key to a lock controller in accordance with the present invention;

FIG. 13 is a message sequence diagram illustrating communication between a key and a lock controller in accordance with the present invention;

FIG. 14 is a timing diagram illustrating the transmission of data as shown in FIG. 13 along with the transmission of power from the key to the lock controller;

FIG. 15 is a flow diagram illustrating exemplary logic for unloading data from a key to the route manager computer;

FIG. 16 is an exemplary screen display for unloading data from the key to the route manager computer;

FIG. 17 is a flow diagram illustrating exemplary logic for generating a report in accordance with the present invention;

FIG. 18 is an exemplary screen display for selecting a report to generate; and

FIG. 19 is an exemplary display of a report generated in accordance with the present invention.

### DETAILED DESCRIPTION OF THE INVENTION

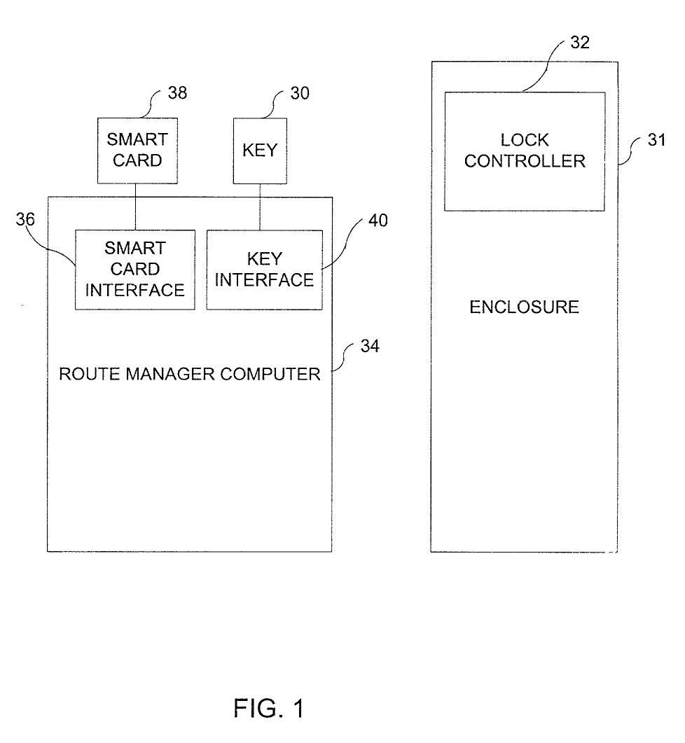

Referring now to the drawings wherein the showings are for purposes of illustrating preferred embodiments of the present invention only, and not for purposes of limiting the same, FIG. 1 is a block diagram illustrating major components of an exemplary embodiment of the present invention. A key 30 is used for controlled access to an enclosure 31 via communications with a lock controller 32. For example, a vending machine having an electro-mechanical lock may have a lock controller 32 in communication with the electro-mechanical lock. The exemplary embodiment illustrated herein is directed to a system for a dispatcher or route manager to control access to vending machines on various routes. It will be appreciated that the present invention can be implemented to control access to various other types of enclosures, including, automated teller machines, cabinets, storage units and other, similar types of enclosures.

The key 30 is loaded with data used to provide controlled access to the lock controller 32. In exemplary embodiments, the data is loaded onto the key 30 by a computer, e.g., route manager computer 34, via a key interface 40.

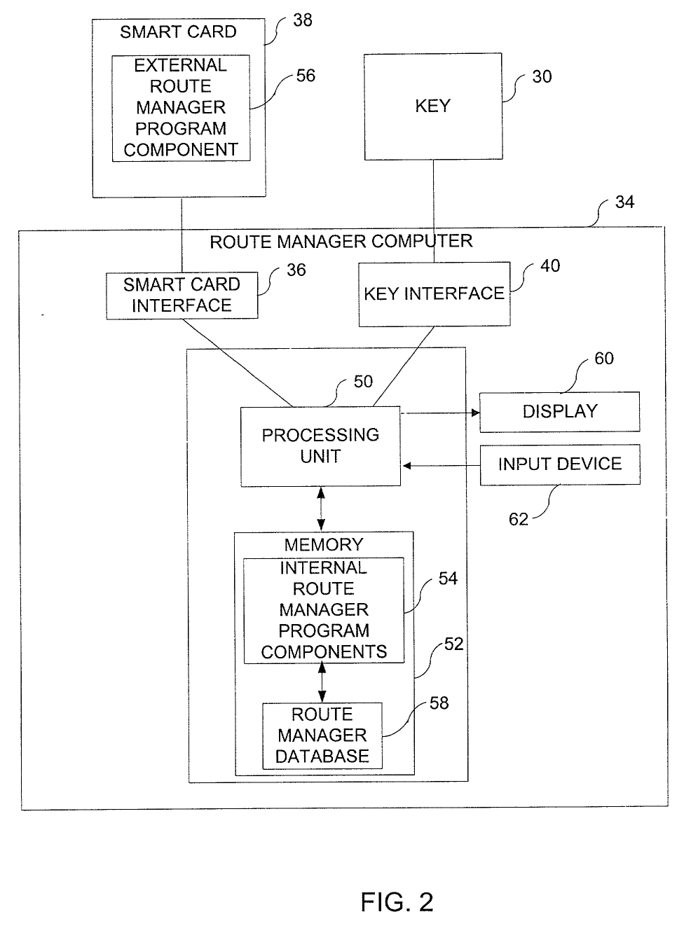

FIG. 2 is a block diagram illustrating major components of the route manager computer 34 shown in FIG. 1. The route manager computer 34 can be any one of various conventional computers, for example a Personal Computer. The route manager computer 34 is used to run a route manager program, such as the one described in further detail later. In exemplary embodiments, such as the one shown in FIG. 2, the components (e.g., executable code, dynamic link libraries, etc.) for the route manager program are stored in multiple locations. In the illustrated embodiment, some of the components for the route manager program 54 are stored in the route manager computer 34 and the remaining components for the route manager program 56 are stored on a smart card 38. Thus, the route manager program can not be loaded and executed unless the smart card 38 is loaded in a smart card interface 36 which is in communication with the route manager computer 34. The route manager components 56 stored on the smart card 38 can vary in different embodiments. For example, in some embodiments, the components on the smart card may be an access code, in other embodiments, the components may be one or more dynamic link libraries, in other embodiments, the components may include dynamic link libraries and an access code, etc. Preferably, the components on the smart card are unique to a particular smart card 38. Preferably, smart card 38 also provides encryption and decryption functions for sensitive data elements within the database 58, software for authenticating passwords and generating various codes used within the key and lock. The cipher variables required for such encryption and decryption are stored on the smart card 38 but are never revealed to the route manager computer 34. These cipher variables are unique to the particular database 58 associated with the smart card 38. Thus, a given smart card 38 can only be used with a given route manager computer 34.

The route manager computer 34 has a processing unit 50. The route manager computer 34 also has a memory 52 for storing data, such as internal route manager components 54 and a route manager database 58. The route manager database is used to store data to be loaded onto keys 30, as well as data unloaded from keys 30. The route manager database can be in various formats. For example, the database can be implemented using Microsoft® Access®.

The route manager computer 34 also has a display 60 used to display a route manager program user interface, such as the one shown and described later. An input device 62, such as a keyboard and a pointing device (e.g., a mouse, trackball, etc.) is used by a user (e.g., a route manager or dispatcher) to interact with the route manager program, for example to load data onto keys 30, to unload data from keys 30 and to display reports generated from data stored in the route manager database 58.

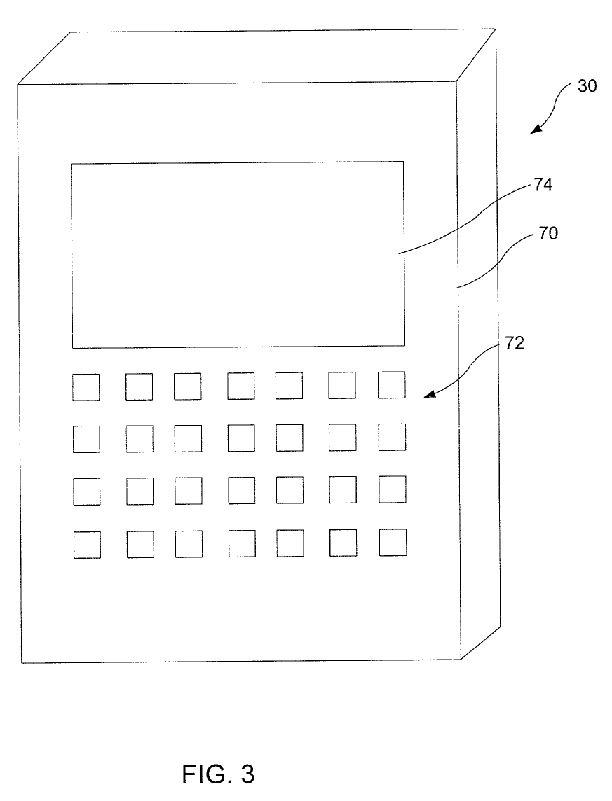

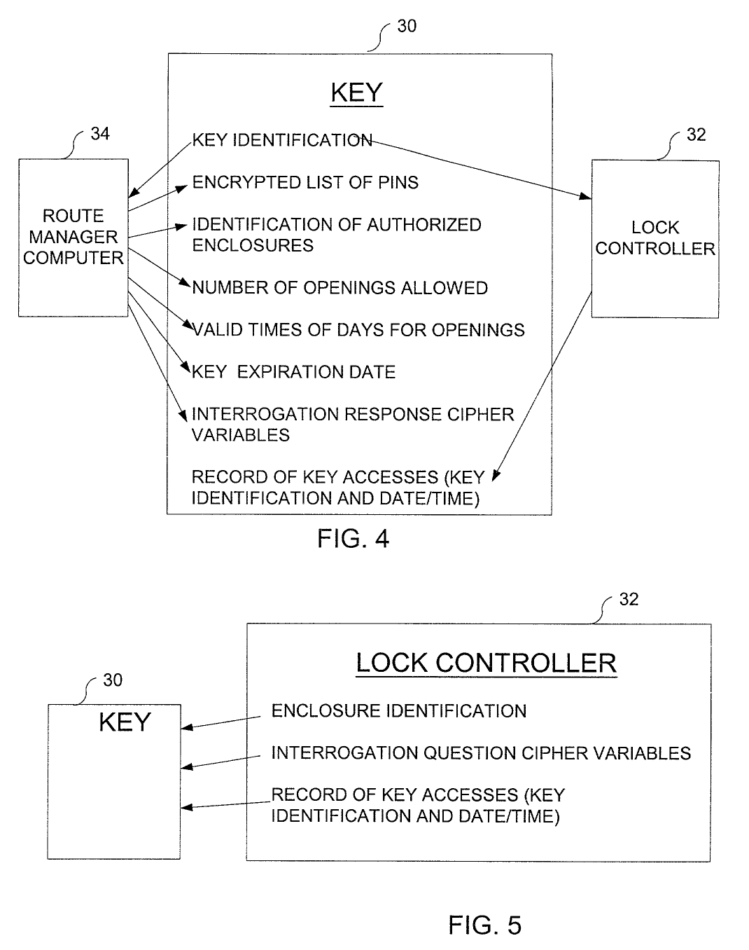

FIG. 3 illustrates an exemplary key formed in accordance with the present invention. Key 30 has a housing 70. Various components (not shown) are stored within the housing. For example, key 30 includes a processor for generating messages, encrypting messages, transmitting messages, receiving messages, and decrypting messages. Key 30 also a data/power link (e.g., ferrite coil)that is a mating link to a data power link in the lock controller 32. The key also has a power supply, such as a battery. A keypad 72 disposed on the key housing 70 is used for entering data, e.g., a Personal Identification Number (PIN). In exemplary embodiments, the key 30 also includes a display 74 for displaying information, e.g., status messages. Key 30 also includes memory for storing data to be transmitted from the key 30 to the lock controller 32. Key 30 also has sufficient memory to store data received from lock controller 32. Exemplary data stored on key 30 is shown in FIG. 4, described next.

As shown in FIG. 4, in exemplary embodiments, key 30 contains data used for controlled access to lock controller 32. A key identification uniquely identifies the key 30. In exemplary embodiments, the key identification may be stored as encrypted data. In exemplary embodiments, the key also includes a list of PINs. The PINs are date sensitive access codes that allow access for a given day of the month. In exemplary embodiments, the key contains 31 PINs, one for each day of the month. The key also includes identification and access codes for lock controllers 32 that may be accessed by the key 30. In exemplary embodiments, a number of openings allowed for the key is stored in the key 30. The key 30 may also store valid times of day for using the key 30 to access lock controllers 32, for example, from 6:00 A.M. to 6:00 P.M. In exemplary embodiments, key 30 also includes an expiration date for the key 30.

Some of the data stored in the key 30 is used to determine if the key should attempt to access a lock controller 32. For example, if the key has expired, the maximum number of opening has been reached or if it is not a valid time of day for the key 30 to access a lock controller 32, the key 30 will not even attempt to access the lock controller 32. Additionally, if an invalid PIN is entered via the keypad 72, the key will not attempt to access the lock controller 32.

The key may also receive and store information obtained from a lock controller 32. For example, upon valid access to a lock controller 32, the lock controller transmits access information, such as key identifications and access times to the key 30.

FIG. 5 illustrates exemplary data stored in a lock controller 32. The lock controller 32 includes an enclosure identification that uniquely identifies the lock controller 32 of a particular enclosure 31. The enclosure identification is transmitted to the key 30 in order to determine if the enclosure is in the list of authorized enclosures for the key 30. In exemplary embodiments, the lock controller 32 also includes a list of cipher variables that are used to construct interrogation questions that are used for access verification. The key 30 includes a list of cipher variables that are used to construct interrogation responses. The lock controller 32 also keeps a record of key accesses (e.g., key identification value and date and time of access). The record of key accesses is transmitted from the lock controller 32 to the key 30. The record of key accesses can then be unloaded from the key 30 to the route manager computer 34.

Referring to FIG. 1, in exemplary embodiments, route manager 34 is in communication with a smart card interface 36, e.g., via a serial port. The present invention includes a route manager program that is used to load information onto keys 30 and to unload information from the keys 30. In exemplary embodiments, such as is shown in FIG. 2, only a portion of the route manager software is stored on the route manager computer 34. The remainder of the route manager software is stored externally, e.g., on a smart card 38. Smart card 38 is read by smart card interface 36 in order to obtain the portion of the route manager program stored on the smart card 38. In exemplary embodiments, the portion of the route manager program 56 stored on smart card 38 is specific to the route manager computer 34. Thus, the route manager program can only be run on a route manager computer 34 which has the proper smart card 38 loaded in the smart card interface 36. Functionality of the route manager program is described in further detail later.

Once the route manager software has been properly loaded, the route manager program can read from and write to keys 30 via a key interface 40.

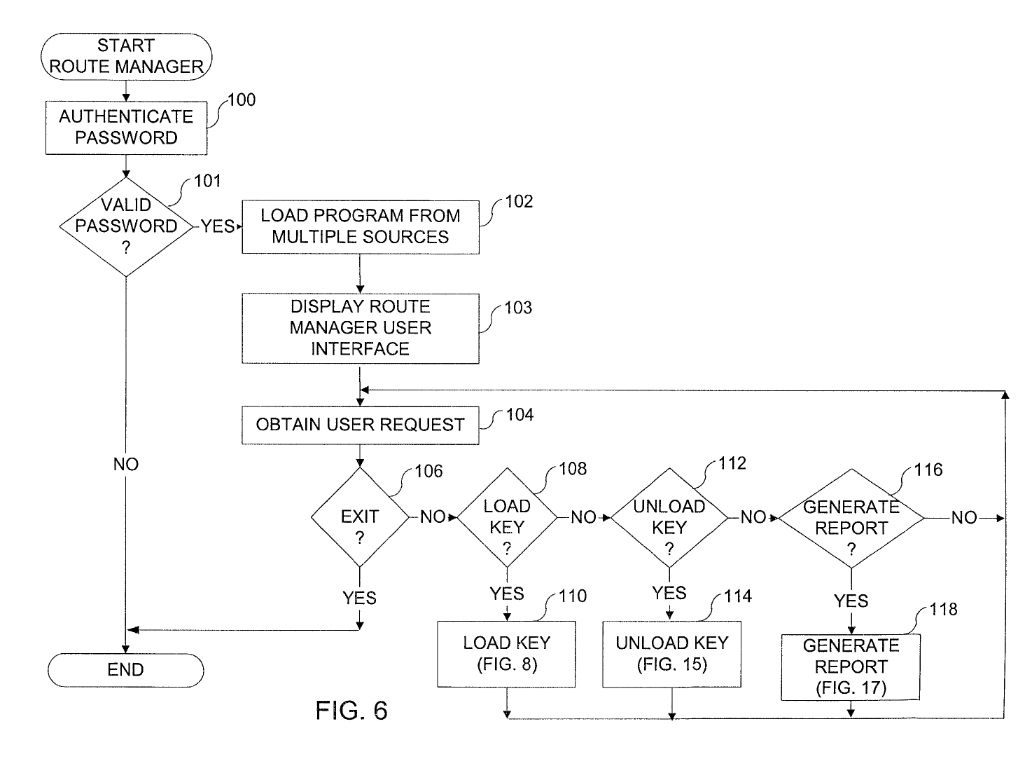

FIG. 6 is a flow diagram illustrating exemplary logic for a route manager program formed in accordance with the present invention. The logic moves from a start block to block 100 where a password entered by the user of the route manager computer is authenticated. If a valid password is not entered (no in decision block 101), the logic of FIG. 6 ends.

If, however, a valid password is entered (yes in decision block 101), the logic proceeds to block 102 where route manager program is loaded from multiple sources. As described above, in exemplary embodiments, a portion of the route manager program is stored on the route manager computer 34 and a portion of the software is stored externally, for example, on a smart card 38 associated with a particular route manager computer 34. Once the route manager program is completely loaded, the logic moves to block 103 where a user interface is displayed on the route manager computer 34.

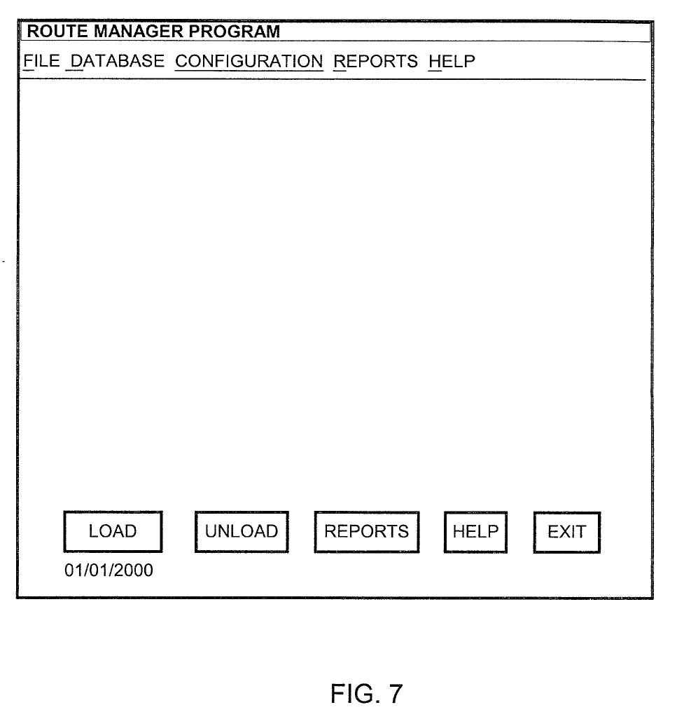

FIG. 7 illustrates an exemplary user interface for a route manager program formed in accordance with the present invention. The route manager program user interface provides controls (e.g., buttons, menus, etc.) that allow a user to perform various functions (e.g., load keys, unload keys, generate reports, etc.).

The logic of FIG. 6 proceeds to block 104 where a user request is obtained (e.g., by the user pressing a button or selecting a menu item). When a request is received, it is processed.

If it is determined in decision block 106 that it is time to exit, e.g., the user wishes to exit or the smart card is removed, the logic of FIG. 6 ends. In exemplary embodiments, if the smart card 38 is removed from the smart card interface 36, after the smart card is entered, the logic of FIG. 6 begins again. In other words, if the smart card 38 is removed, the user must again enter the password for authentication before the program is reloaded and processing begins.

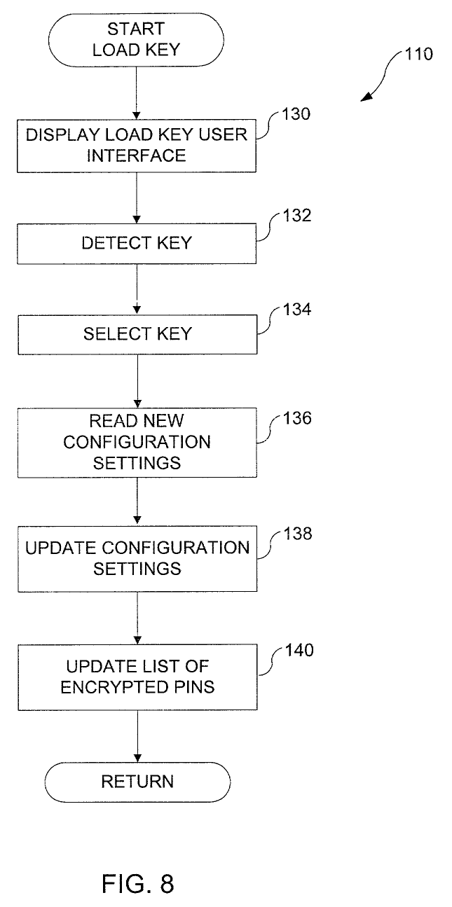

If it is not time to exit (no in decision block 106), the requested route manager function is performed. If the request is a load key request (yes in decision block 108), the logic moves to block 108 where the key is loaded. Exemplary logic for loading a key is shown in FIG. 8 and described next.

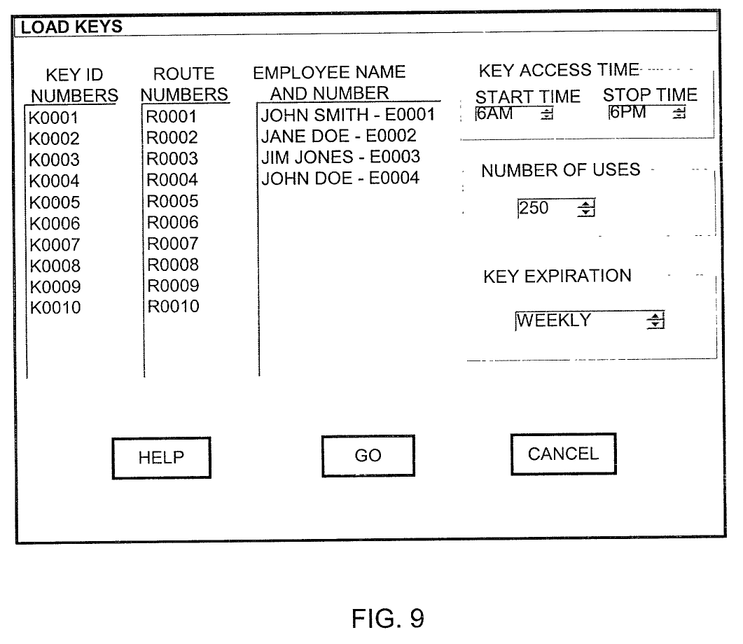

FIG. 8 is a flow diagram illustrating exemplary logic for loading a key. The logic moves from a start block to block 130 where a load key user interface is displayed. FIG. 9 illustrates an exemplary load key user interface formed in accordance with the present invention.

The logic of FIG. 8 proceeds to block 132 where a key is detected. In exemplary embodiments, multiple key interfaces 40 may be included and multiple keys 30 can be detected at the same time. A detected key is selected. See block 134. For example, as shown in FIG. 9, a list of all detected keys is displayed and the user selects the desired key. After selecting a key, the user (e.g., route manager) can configure the settings for the selected key. For example, the user can define valid key times. For example, the key 30 may only be valid from 6 A.M. to 6 P.M. In exemplary embodiments, the key may only be valid on certain days (e.g., weekdays). The user can also specify a maximum number of openings for the key for the current key period. The current key period ends on the key expiration date. The key expiration date is also configurable by the user. As shown in FIG. 9, in exemplary embodiments, such as a vending machine route, a key 30 can be associated with a given person and a given route. The key also contains an internal date and time. The user can view the internal date and time of the key. The internal date and time of the key can be updated. In exemplary embodiments, the internal date and time of the key is automatically updated to the same date and time as the route manager computer 34. In alternative embodiments, the internal date and time of the key can be updated manually by the user instead of or in addition to being automatically updated by the route manager computer 34.

After the user has updated the configuration settings as desired, the updated settings can be read (block 136) and loaded onto the key (block 138). For example, as shown in FIG. 9, the user presses a “GO” button on the load user interface to indicate that the settings should updated. The settings information is retrieved (block 136) and the information is stored in the route manager computer and in the key (block 138). In exemplary embodiments, encrypted elements of the settings information are modified by smart card 38 prior to being stored on the key 30. They are decrypted from their database encryption format and then immediately re-encrypted to their key format. The non-encrypted data elements never appear outside of smart card 38. The key 30 also includes a list of PINs. When the key 30 is loaded, a new list of PINs may be generated and loaded onto the key. See block 140. The logic of FIG. 8 then ends and processing returns to FIG. 6.

After the key 30 is loaded, the service technician can use the key 30. In order to use the key 30, the PIN for the current day must be obtained. For example, the service technician can telephone the route manager or dispatcher. The route manager or dispatcher can load and run the route manager program and display the PIN for the day for the service technician. In exemplary embodiments, only the PIN for the current day can be decrypted and displayed by the route manager computer 34.

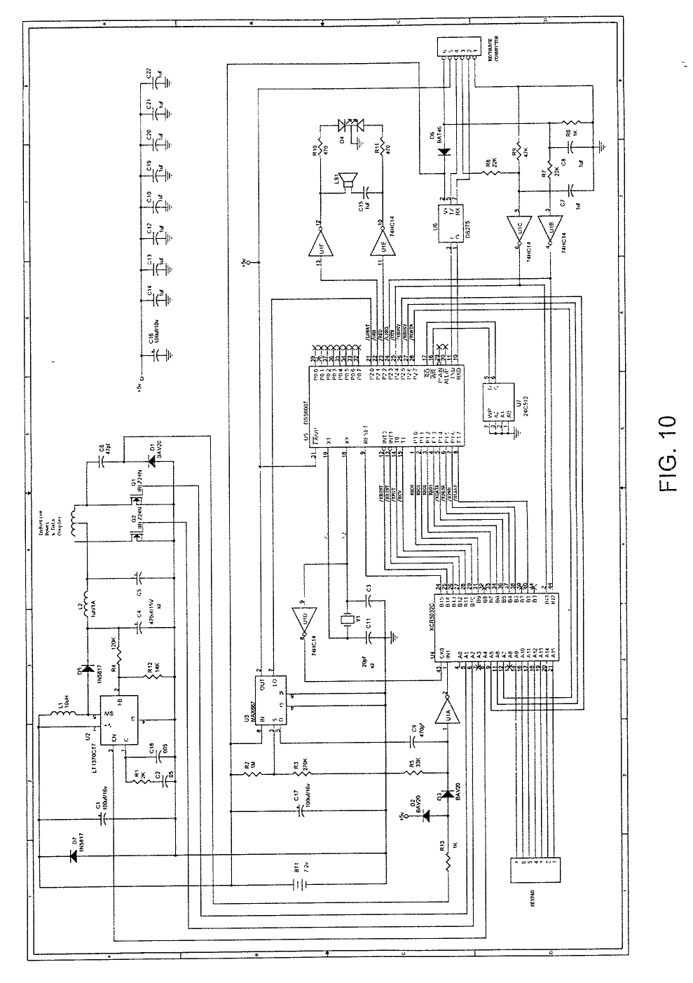

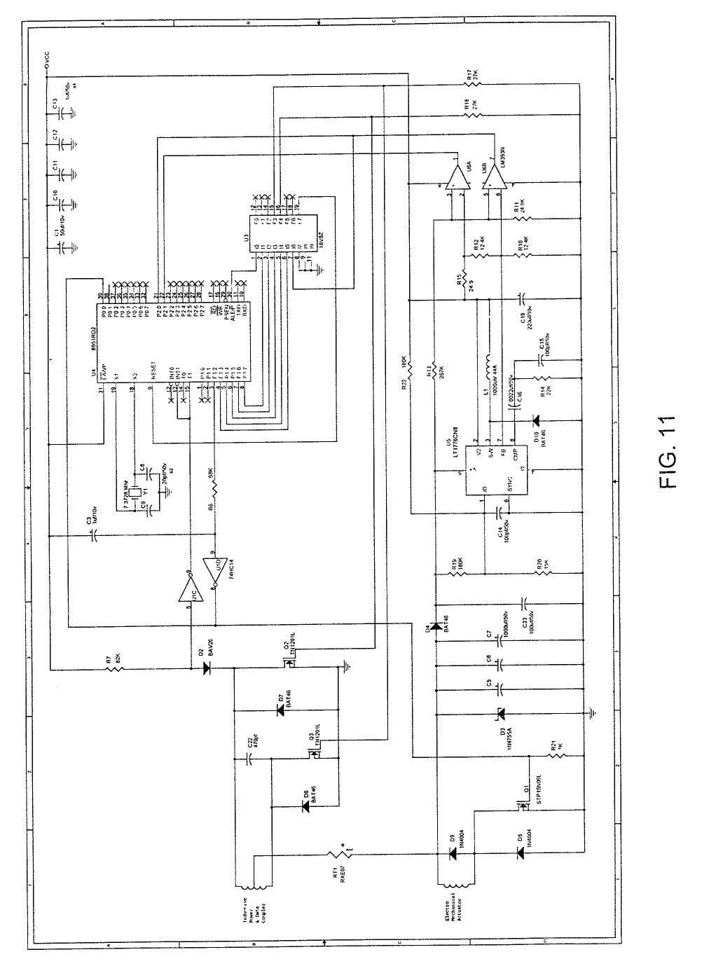

Once the key has been programmed and its batteries have been charged, the user or service technician is able to access the enclosures identified on the key. In exemplary embodiments, the user places the key on the outer door of the enclosure. As shown in the schematic illustration of an exemplary key 30 of FIG. 10 is a 30, key 30 includes a programmable logic device 80 that contains a power/data transmission modulator and data reception synchronizer. The key 30 also includes a key pad interface 82 for entry of data, such as a PIN. FIG. 11 is a schematic of an exemplary lock controller 32 formed in accordance with the present invention. Typically, the lock controller 32 of the enclosure 31 includes a microprocessor and a memory for storing data or information such as when and how long the door of the enclosure 31 has been opened and by whom. The lock controller also has a data/power link that typically comprises an inductive coupling, such as ferrite coil which enables indirect, inductive power transfer through the door over a desired air gap. The data/power link of the lock controller is typically positioned at a corner of the door frame so that the key can be slid into the corner and into engagement with the outer door frame to automatically locate and place the inductive coupling or link of the key controller in registry with the inductive coupling of the data/power link of the lock controller. In exemplary embodiments, such as the one shown in FIG. 11, the data demodulator and transmission synchronizer of the lock controller 32 are both implemented in firmware. Data transfer between the key and the lock controller can be accomplished using various known techniques, for example, electromagnetic dynamics, radio frequency transfer or an infrared link.

In order to gain access to an enclosure in accordance with the present invention, the user first enters a PIN using the keypad 72 of key 70. If the PIN is invalid, no further processing occurs (e.g., the key 70 will not transmit any power or data until a valid PIN is entered). In addition to entering a valid PIN, the key must not have expired, must not have exceeded the maximum number of openings and the time must be a time which the key may be used. In alternative embodiments, the PIN is transmitted to the lock controller and the lock controller validates the PIN. If the lock controller determines that the PIN is invalid, the key ceases transmission of power and data.

If a valid PIN has been entered, the key has not expired, the maximum number of openings has not been exceeded and the time is within the valid time range, the user places the key in the proper position on the enclosure door so that the power/data link of the key is in registry with the power/data link of the lock controller of the enclosure. The key 30 then begins wireless transmission of power to the lock controller 32. Simultaneously, data is transmitted and received between the key 30 and the lock controller 32. Power from the battery of the key is transmitted inductively through the door across an air gap to the mating data/power link and to the lock controller to energize the data/power link to the lock controller. The wireless transmission of power from the key 30 to the lock controller 32 simultaneous with the transmission of data between the key 30 and the lock controller 32 is described in further detail next.

U.S. Pat. No. 5,619,192, entitled “Apparatus and method for Reading Utility Meters” discloses a system and method for an electronic reader having means to conductively and inductively transmit power and/or an interrogation command to a meter to be read at any selected one of a plurality of frequencies and for the reader to include a receiver for receiving data inductively from a meter being read. The entire contents of U.S. Pat. No. 5,619,192 are incorporated by reference herein.

In exemplary embodiments of the present invention, a system such as that described in U.S. Pat. No. 5,619,192 is used for wireless transmission of power from the key 30 to the lock controller 32. Additionally, key 30 can transmit data to lock controller 32 simultaneously with the transmission of power. The two-way data communication of the present invention allows for controlled access to the enclosure 31 having a lock controlled by lock controller 32. As described below, selective access to the enclosure having a lock controlled by lock controller 32 is achieved by two-way communication between the key 30 and the lock controller 32 which includes the transmission and receipt of variable signals for validating that the key is authorized to access the enclosure. The variable signals transmitted between the key 30 and the lock controller 32 deter detection and duplication, and thus prevent unauthorized access to the enclosure.

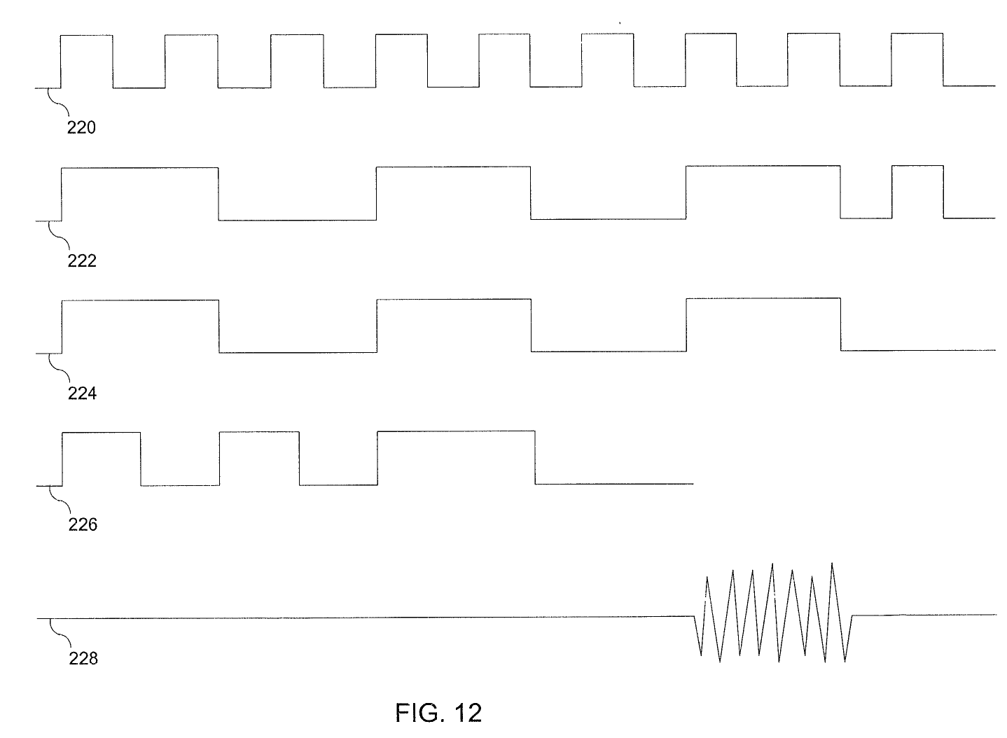

FIG. 12 is an exemplary illustration of phase/frequency modulation patterns of half-duplex data transmission simultaneous with power delivery. In exemplary embodiments of the present invention, the data is transmitted one bit at a time at a rate of 1896.3 bits/second and the data is received at a rate of 2275.6 bits/second. In the exemplary embodiment illustrated, when data is not being transmitted, power (unmodulated carrier signal) is transmitted at a frequency of 17.067 KHz 220. When a “zero” bit is being transmitted, the data is transmitted as shown at frequencies of 5.689 KHz and 17.067 KHz 222. A “one” bit is transmitted at a frequency of 5.689 KHz 224. When the key 30 is ready to receive a data transmission, it transmits at frequencies of 11.378 KHz and 5.689 KHz followed by a receive window 226. The lock controller 32 transmits one bit during the receive window. If the transmission by the lock controller is a “zero” bit, a 204.8 KHz burst is transmitted 228. If the bit being transmitted by the lock controller is a “one” bit, there is no burst. If there is more data to be received from the lock controller 32 by the key 30, the receive sequence with the receive window 226 and the lock controller transmission 228 are repeated until an entire message from the lock controller 32 is received by the key 30.

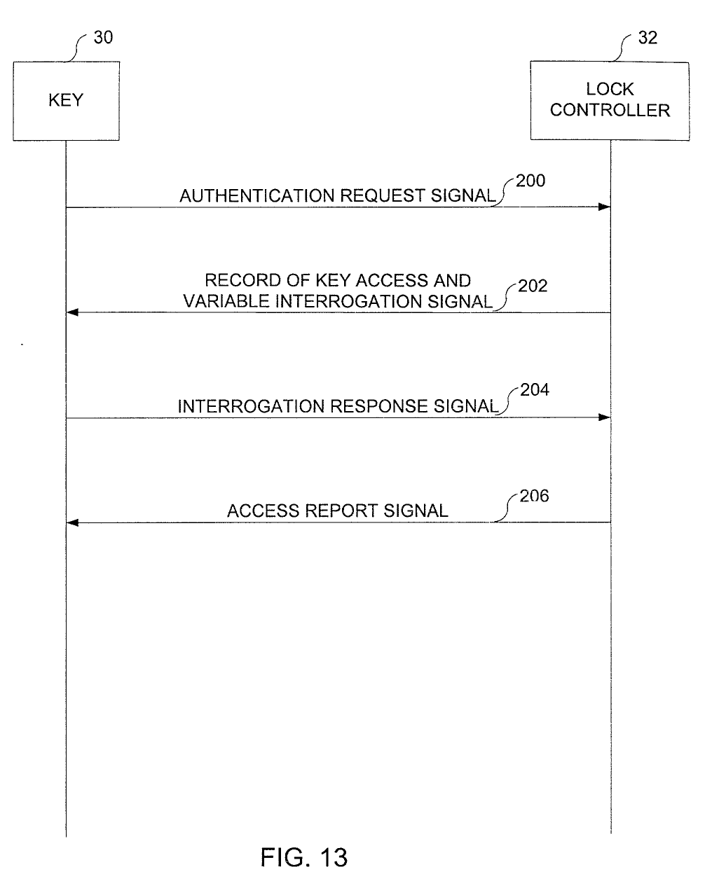

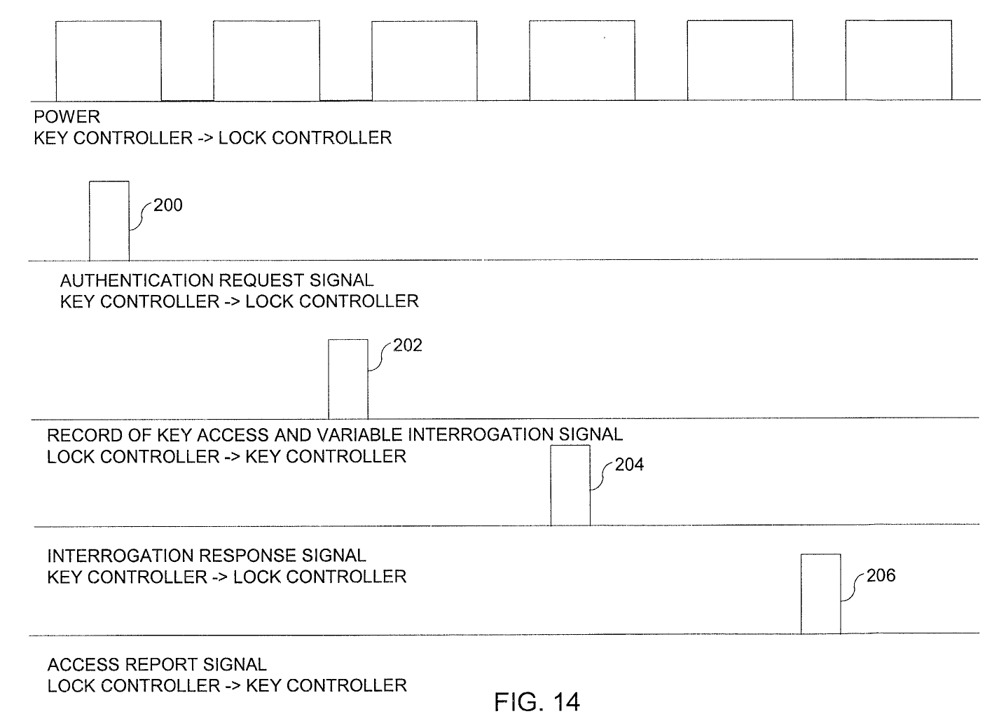

FIG. 13 is a message flow diagram illustrating messages communicated between the key 30 and the lock controller 32. In exemplary embodiments, the key 30 includes a keypad 72. The service technician enters the PIN for the day using the keypad 72 on the key 30. If the PIN is correct, an indication is given, e.g., the key emits a sound (e.g., a click or a beep) and/or an “OK” message is displayed on the key display 74. Once the service technician has been validated as having entered the correct PIN for the day, the key 30 must be lined up with the lock controller 32 within a short period of time (e.g., 10 seconds). Once the key has been lined up with the lock controller, the key begins to transmit power. In exemplary embodiments, the key transmits power repeatedly in short bursts, e.g., 1000 times a second. The key transmits data simultaneously with power. The lock controller 32 transmits data to the key 30 between the key's power transmission cycles, as shown in FIG. 14. In exemplary embodiments, the power transmissions are synchronized so that the lock controller 32 knows when power is not being transmitted, such as is shown in 226 and 228 of FIG. 12. Power is transmitted until either sufficient power has been transmitted to open the lock of the enclosure or the transmission is aborted. The transmission may be aborted by the user removing the key 30 or when proper validation is not achieved.

After a valid PIN has been entered and the key 30 is properly aligned with the lock controller 32, the key commences transmitting power as shown in FIG. 14. The key 30 builds an authentication request signal 200 and transmits it to the lock controller 32. In exemplary embodiments, the key 30 builds an authentication request message that includes a key identification and a date/time. Prior to building the authentication request message, the key 30 verifies that the PIN entered is valid, that the user has not exceeded the maximum number of allowable openings and that the date/time is an allowable date/time. If the verification is not successful, the authentication request message is not built and the key 30 will not transmit the authentication request message and will cease transmitting power. If the validation is successful, the authentication message is built and encrypted. The encrypted authentication request signal 200 is then transmitted from the key 30 to the lock controller 32. The key increments the number of openings to ensure that the number of openings does not exceed the allowable number of openings.

Upon receipt of the authentication request signal 200, the lock controller 32 decrypts the authentication request message. The lock controller 32 then stores an entry indicating the key identification and date/time of access. The lock controller 32 builds a variable interrogation message that includes an enclosure identification, a record of previous accesses and an interrogation question. The lock controller 32 has multiple stored cipher variables and a random number generator that are used to construct interrogation questions and their expected replies used to provide additional security. Use of variable interrogation questions deters detection and duplication of the signals communicated between the key 30 and the lock controller 32. The variable interrogation signal 202 is encrypted and transmitted from the lock controller 32 to the key 30.

Upon receipt of the variable interrogation signal 202, the key 30 decrypts the variable interrogation signal. The key 30 then builds an interrogation response message that includes an answer to the variable interrogation question. The interrogation response message is encrypted and transmitted from the key 30 to the lock controller 32 as an interrogation response signal 204.

The lock controller 32 decrypts the interrogation response signal 204 and validates the reply to the interrogation question. The lock controller 32 sends an access report signal 206 to the key 30. The access report signal includes an indication of whether sufficient power has been transmitted. Access report signals 206 are sent periodically until the lock controller 32 has received sufficient power to open the lock. The key 30 continues to transmit power until a message is received at the key 30 from the lock controller 32 that sufficient power has been received by the lock controller. When the key receives a message that sufficient power has been received, the key 30 ceases transmission of power. In exemplary embodiments, an indication is also provided by the key 30 (e.g., an audible and/or visual indication at the key 30) that sufficient power has been received by the lock controller 32.

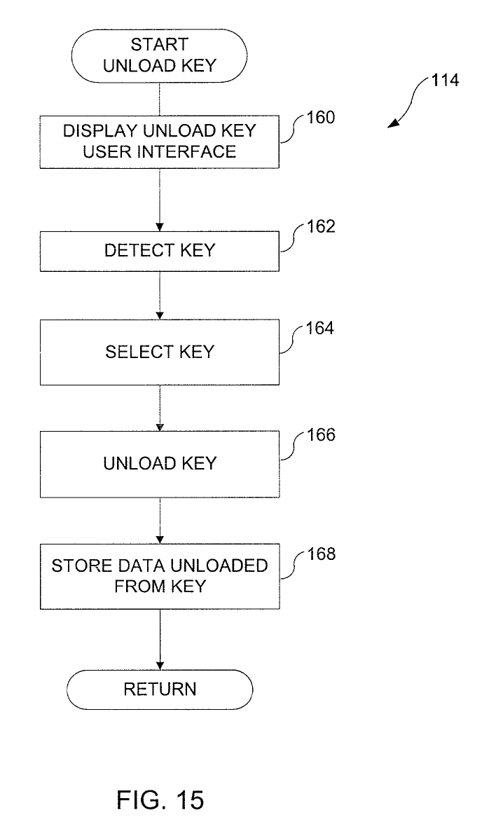

Returning to FIG. 6, if the user (e.g., route manager) wishes to unload data from a key (yes in decision block 112), the logic moves from decision block 112 to block 114 where the key is unloaded as shown in FIG. 15 and described next.

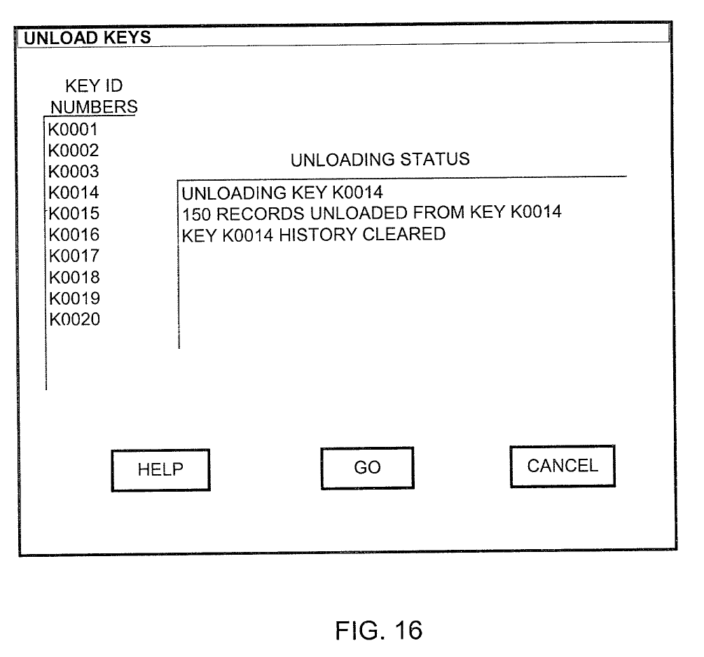

The logic of FIG. 15 moves from a start block to block 160 where an unload user interface is displayed. FIG. 16 shows an exemplary unload key user interface. As with the load key function, the key 30 is placed in the key interface 40. The route manager program on the route manager computer 34 detects a key 30 loaded in the key interface 40. The logic moves to block 162 where a key is detected. For example, as shown in FIG. 16, multiple keys may be detected at the same time from multiple key interfaces 40. A list of keys is displayed as shown in FIG. 16. The user can select a key to unload from the list of available keys. See block 164. After selecting a key, the user indicates that the selected key should be unloaded, e.g., by pressing an “GO” button as shown in FIG. 16. The logic proceeds to block 166 where the key 30 is unloaded. When the key is unloaded, data from the key 30 is transmitted from the key 30 to the route manager program. The transmitted data includes one record of key accesses from each of the enclosures 31 that were in communication with the key 30 since the previous upload process. The logic then moves to block 168 where the route manager program stores the data in the route manager database 58. After the key has been unloaded, the logic of FIG. 15 ends and processing is returned to FIG. 6.

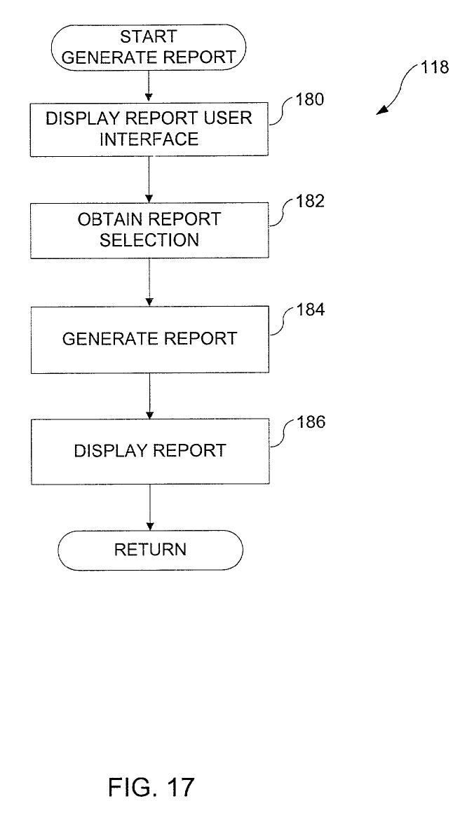

Returning to FIG. 6, if the user wishes to generate a report (yes in decision block 116), the logic moves from decision block 116 to block 118 where a report is generated. FIG. 17 illustrates exemplary logic for generating a report.

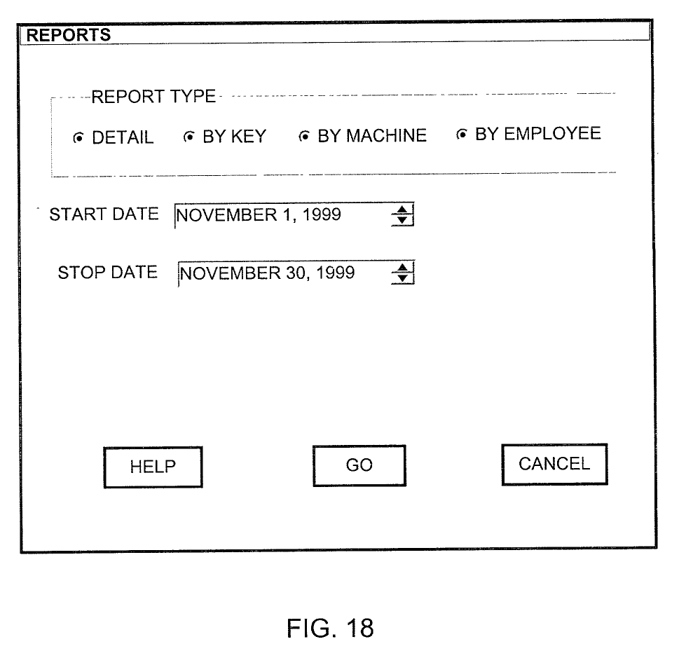

FIG. 17 is a flow diagram illustrating exemplary logic for generating a report in accordance with the present invention. The logic moves from a start block to block 180 where a user interface for available reports is displayed. FIG. 18 is an exemplary user interface for selecting available reports. For example, a report may be generated for a selected key 30 for a specified period of time. The report will display access (e.g., a key identification and date/time) for the specified key during the specified period of time.

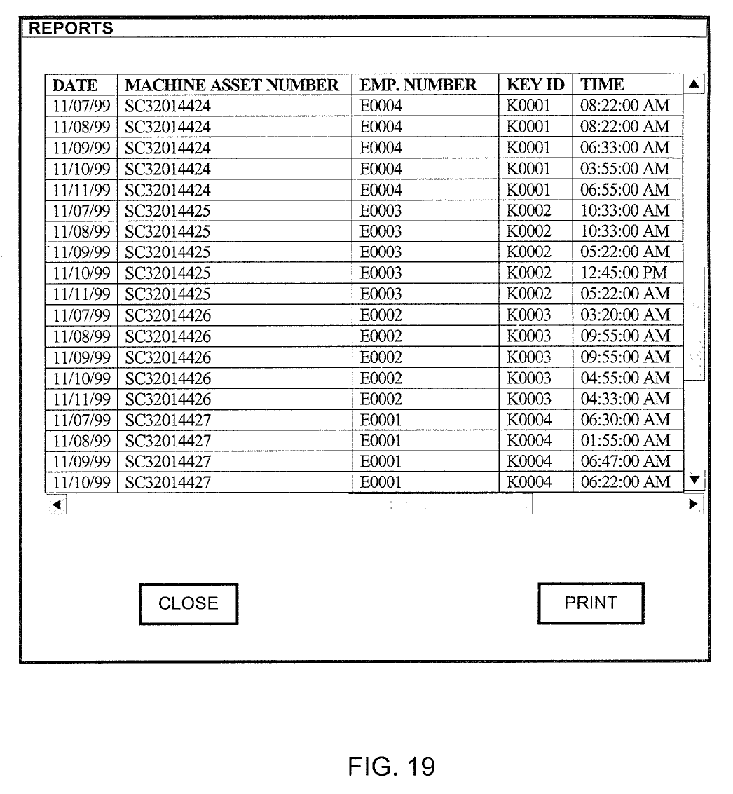

After selecting the desired report (block 182), the logic of FIG. 17 moves to block 184 where the desired report is generated. For example, the route manager database 58 is queried to obtain the desired report data. The logic then moves to block 186 where the report is formatted and displayed. FIG. 19 illustrates an exemplary report display. After the report is displayed, the logic of FIG. 17 ends and processing returns to FIG. 6.

Returning to FIG. 6, after the desired function has been performed (e.g., load key in block 110, unload key in block 114 or generate report in block 118), the logic of FIG. 6 returns to block 104 to obtain the next user request. The logic of blocks 104-118 is repeated until it is time to exit (yes in decision block 106). When it is time to exit, the logic of FIG. 6 ends. It will be appreciated that functions other than those shown in FIG. 6 may be available in a route manager program formed in accordance with the present invention. For example, there may be a help function, a configuration function (e.g., for setting date/time, etc.), a database function for examining and updating the database, etc.

Additional modifications and improvements of the present invention may also be apparent to those of ordinary skill in the art. Thus, the particular combination of parts described and illustrated herein is intended to represent only a certain embodiment of the present invention, and is not intended to serve as a limitation of alternative devices within the spirit and scope of the invention.

1. A key for wirelessly powering and selectively allowing access to an enclosure identified by an enclosure identification, the enclosure having an otherwise unpowered enclosure lock controller to control an electric enclosure lock mechanism, the key and the lock controller in two-way communication for transmitting and receiving variable signals for validating that the key is authorized to access the enclosure, the variable signals being alternately transmitted between the key and the lock controller to deter detection and duplication of the variable signals to prevent unauthorized access to the enclosure, the key comprising:
a) a housing;
b) a processor located within the housing, the processor operative to build the variable signals for transmission from the key to the lock controller and to interpret the variable signals received by the key from the lock controller;
c) a storage device located within the housing in communication with the processor, the storage device operative to store data for building and interpreting the variable signals being alternately transmitted between the key and the lock controller for validating that the key is authorized to access the enclosure;
d) a data transmitter located within the housing in communication with the processor, the data transmitter operative to wirelessly transmit signals from the key to the lock controller, to inductively transmit an access request signal to the lock controller upon proper alignment with the lock controller, and to transmit an interrogation response signal in response to receiving to a variable interrogation request;
e) a data receiver located within the housing in communication with the processor, the data receiver operative to receive the variable interrogation signal; and
f) a power transmitter located within the housing in communication with the processor for wirelessly transmitting power to the lock controller, the power transmitter and the data transmitter simultaneously wirelessly transmitting data and power to the lock controller.

2. The key of claim 1, further comprising:
a) a plurality of date sensitive key activation codes stored in the storage device; and
b) a keypad located on the external surface of the housing used for entering one of the date sensitive key activation codes.

3. The key of claim 1, further comprising a display located on the external surface of the housing.

4. The key of claim 1, further comprising receiving an access report signal at the key from the lock controller, the access report signal indicating whether sufficient power has been transmitted to unlock the enclosure.

5. The key of claim 1, wherein the key selectively allows access to the enclosure via wireless simultaneous transfer of data and of power to the lock controller using a method of transmitting the variable signals comprising:
a) transmitting the access request signal identifying the key from the key to the lock controller;
b) receiving by the key, the variable interrogation signal from the lock controller, in response to the access request signal;
c) decoding the variable interrogation signal to determine an enclosure identification and identify a variable interrogation question, the variable interrogation question corresponding to one of a plurality of possible interrogation questions;
d) validating that the key is authorized to access the enclosure by comparing the enclosure identification to a list of authorized enclosure identifications stored in the key;
e) computing the interrogation response signal using a selected stored cipher variable corresponding to the interrogation question and the enclosure identification, in response to a key validation;
f) transmitting the interrogation response signal from the key to the lock controller; and
g) repeatedly transmitting power from the key to the lock controller until the key receives a signal from the lock controller indicating that sufficient power has been received by the lock controller to send an open signal to the enclosure lock.
